(19) United States
(12) Patent Application Publication
(10) Pub. No.: US 2025/0322766 A1
(43) Pub. Date: Oct. 16, 2025

(54) AI POWERED DYNAMIC STORY GENERATION SYSTEM FOR INDIVIDUALIZED LEARNING AND A METHOD THEREOF

(71) Applicant: 2hr Learning, Inc., Austin, TX (US)

(72) Inventors: Vicky Biswas, Dehradun (IN); Aman Chandra, Bengaluru (IN)

(73) Assignee: 2hr Learning, Inc., Austin, TX (US)

(21) Appl. No.: 19/177,475

(22) Filed: Apr. 11, 2025

Related U.S. Application Data
(60) Provisional application No. 63/632,998, filed on Apr. 11, 2024.

(51) Int. Cl. G09B 17/00; G06F 16/9535; G06F 40/166; G09B 3/06; H04L 67/306

(52) U.S. Cl. CPC G09B 17/003; G06F 16/9535; G06F 40/166; G09B 3/06; H04L 67/306

(57) ABSTRACT

An artificial intelligence (AI) story generation environment includes a story generation system and an AI story generation system. The story generation system guides and constrains the AI story generation system to transform guidance information, constraint information, and input data into a story that aligns with the guidance, constraint, and input data including alignment with educational standards. The story generation system further includes a user interface having an integrated chatbot configured to enable communication between a user and the story generation system. A user profile is created based on details provided by the user either directly through the user interface or via interaction of the user with the chatbot. The details provided by the user includes one or more user interests, one or more life incidents, hobbies, and so on. A default reading level value is assigned to the user profile based on the received user details.

### CROSS-REFERENCE TO RELATED APPLICATION

This application claims the benefit under 35 U.S.C. § 119 (e) and 37 C.F.R. § 1.78 of U.S. Provisional Application No. 63/632,998, filed Apr. 11, 2024, which is incorporated by reference in its entirety.

### FIELD OF THE INVENTION

The present invention relates in general to the field of electronics, and more specifically to utilize an artificial intelligence story generation system to dynamically generate a personalized story based on a user's interest and reading level value for personalized learning.

### BACKGROUND OF THE INVENTION

E-learning technology is evolving at a rapid rate. The rapid advancement in adoption of e-learning technology is mainly due to the constructive learning outcomes provided by online learning, as the students are allowed to actively participate in learning from anywhere in the world at any time.

Conventional e-learning platforms rely on static content that often follows a ‘one-size-fits-all’ approach. This approach may lead to disengagement and limited comprehension among students, as the content may not resonate with their unique backgrounds and preferences.

While creating personalized content holds immense promise in revolutionizing adaptive and personalized learning, it also presents notable challenges, particularly due to the manual efforts required for data collection and curation. These manual tasks, while crucial, often act as bottlenecks, hindering the efficiency and scalability of the content creation process for e-learning platforms.

One significant challenge lies in collecting user data based on interactions, preferences, or feedbacks. Understanding the layers of customization required to curate personalized data demands meticulous attention and analysis of user requirements. This manual effort involves combing through vast details of information, different patterns and insights before getting started with the content creation process. Such manual tasks not only require significant time and resources but also risk human error and bias, potentially compromising the accuracy and effectiveness of the adaptive learning experience.

Moreover, traditional e-learning platforms present content in a conventional format including lessons in text, audio or video format. The search of finding a new format along with creating captivating content that inspires students adds another layer of complexity to the manual efforts required in generating personalized content.

### SUMMARY

A story method and corresponding system that include:
providing a story generation computer system having a user interface and an integrated chatbot;
creating a user profile including one or more user details, wherein creating the user profile includes providing user inputs directly through the user interface or via interacting with the chatbot;
assigning a reading level value to the user profile based on the received user details;
storing the user details and the default reading level value in a memory operatively coupled to the user interface;
identifying one or more story topics based on the user details and the default reading level value;
guiding and constraining one or more AI engines to transform the user profile, reading level, and story topics into a story, wherein uiding and constraining one or more AI engines to transform the user profile, reading level, and story topics comprises:
   identifying user details to be used in the story including at least one character and one or more incidents or interests from the user profile to personalize the story;
   generating the story based on the identified details and the default reading level value of the user; and
   converging the reading level value of the story with the user's default reading level value using an iterative reading level value adjustment process in order to adapt with the complexity level of the story.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary artificial intelligence (AI) story generation environment.

FIG. 2 depicts an exemplary artificial intelligence (AI) story generation process for generating a personalized story based on user's interest and reading level level.

FIG. 3 depicts a flow diagram showing details of steps involved in the story generation process.

FIGS. 4-5 depict user interfaces 400 and 500 displaying details stored in an exemplary user profile.

FIG. 6 depicts a user interface displaying an exemplary dashboard of the story generation system.

FIGS. 7-8 depict exemplary views of a user interface where a user interacts with the story generation system via a chatbot for story generation.

FIGS. 9 and 10 depict exemplary views of a user interface providing options to the user for selection of topic of his/her choice for story generation.

FIGS. 11-12 depict exemplary stories generated by the story generation process of FIG. 2.

FIG. 13 depicts an exemplary network environment in which the system of FIG. 1 and the process of FIG. 2 may be practiced.

FIG. 14 depicts an exemplary computer system.

### DETAILED DESCRIPTION

An artificial intelligence (AI) story generation environment includes a story generation system and an AI story generation system. The story generation system guides and constrains the AI story generation system to transform guidance information, constraint information, and input data into a story that aligns with the guidance, constraint, and input data including alignment with educational standards. The story generation system further includes a user interface having an integrated chatbot configured to enable communication between a user and the story generation system. A user profile is created based on details provided by the user either directly through the user interface or via interaction of the user with the chatbot. The details provided by the user includes one or more user interests, one or more life incidents, hobbies, and so on. A default reading level value is assigned to the user profile based on the received user details. A memory is operatively coupled to the user interface for storing one or more user details and a default reading level value of the user. The one or more user details obtained through the user profile is attached to a user profile.

The AI story generation system further comprises a story topic identifier for identifying at least one story topic based upon the one or more user details, the reading level value of the user and one or more educational standards. The one or more educational standards include Common Core State Standards (CCSS), NGSS (Next Generation Science Standards) and AP.

The story topic identifier identifies the story topic for the story generation by receiving one or more educational topics from one or more curriculums relevant to the user profile. The relevancy of curriculum is based on age or level of education of the user. The identified educational topics are then compared to the user profile and recent interactions of the user with the chatbot. Finally, the one or more educational topics that match the user profile are extracted. The story topic identifier incorporates an algorithm for selecting at least one story topic for the story generation from the user profile in order to prioritize one or more interests and one or more incidents extracted from the recent chat interaction of the user and the user interface over those stored in the user profile for increased relevance.

The AI story generation system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than both any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics. For example, in an educational context, the desired outputs should meet grade level criteria such as reading levels, word counts, word phrase sophistication, student answer accuracies, and so on.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the outputs described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models-Algorithms that analyze data, recognize patterns, and make predictions.
2. Neural Networks-Deep learning architectures that mimic the human brain for tasks like image and speech recognition.
3. Data Processing Module-Handles raw data input, transformation, and feature extraction.
4. Inference Engine-Applies trained models to make real-time decisions based on new data.
5. Optimization Algorithms-Improves model efficiency, reducing errors and improving predictions.
6. Natural Language Processing (NLP) Module-Enables AI engines to understand, interpret, and generate human language (e.g., chatbots, voice assistants).
7. Computer Vision Module-Allows AI to interpret and analyze images or videos.
8. Reinforcement Learning Mechanism-Helps AI learn from trial and error, optimizing performance over time.
9. API Interface-Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

The AI story generation system further includes a story generator for automatically generating a story based upon the user's selection of the story topic using AI engines. The AI engines used for generating a personalized story includes prompt engineering and prompt chaining techniques. The story generator further comprises a content identifier, a content generator and a reading level value adjustment module. The content identifier identifies the user details to be used in the story which includes at least one character and user details from the user's profile to personalize the story. The content generator generates the story based on the identified user details and the default reading level value of the user. Further, the reading level value adjustment module converges the reading level value of the story with the user's reading level value based on an iterative reading level value adjustment process. The reading level value adjustment module is configured to divide the broad range of reading level values into distinct reading level buckets and comparing the default reading level value to reading level buckets thereby adjusting the complexity of the generated story according to the relevancy of the user reading level value to corresponding reading level bucket. The story generator is further configured to generate personalized stories with different levels of complexities which includes low, medium and high reading level values to maintain with users reading capabilities.

Finally, the user interface which is operatively coupled to the story generation system displays the generated personalized story to the user on the user device. When the user is done with reading the whole story, a MCQ generator generates multiple-choice questions (MCQs) based on the generated story for assessing reading capabilities of the user. The reading level value of the user is updated based on the response of the user to the MCQs. For example, if the user gives all the answers correctly then next time the generated story would be of a level higher than the previous one and vice versa.

A feedback module operatively coupled to the story generation system allows users to provide feedback related to the story through chatbot interaction. Also, the feedback is collected based on the performance of the user in multiple choice questions (MCQs).

Thus, the story generation environment does not require any manual interventional and thus saves a lot of time for the user. Further, the artificial intelligence (AI) story generation environment provides a personalized story which is generated on a real-time basis based on the user's interests, user's reading level value and one or more educational standards. The generated story gets updated on a real time basis based on the interaction of the user with the story generation system.

While the artificial intelligence (AI) story generation environment presented herein makes use of specific reference to dynamic curriculum aligned story generation for the students, but it is to be appreciated that the description is also equally applicable for school teachers, parents teaching their child at home, student doing self-tutoring, coaching tutors, adults learning for their career development, employees in corporate training, parents for parenting education, children for craft, music and other education, elderly people for medical guidance, medical staff for guidance and so on.

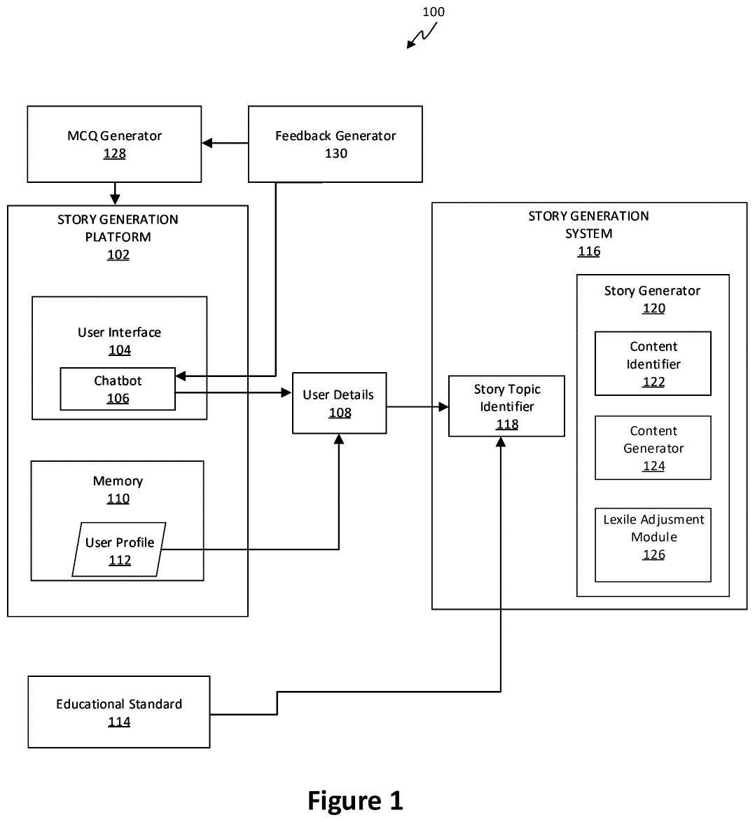

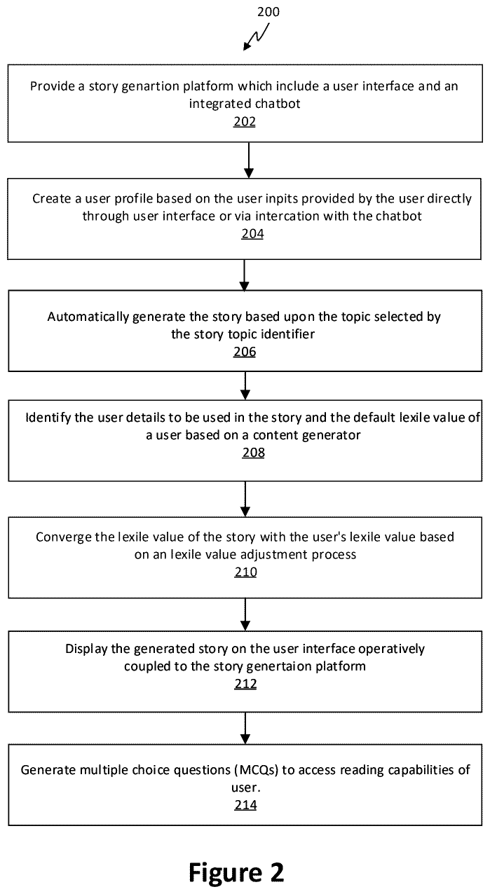

FIG. 1 depicts an exemplary artificial intelligence (AI) story generation environment 100 to generate one or more personalized stories for a user. FIG. 2 depicts an exemplary story generation process 200 utilized by the AI story generation system 100.

Referring to FIGS. 1 and 2, in operation 202, a user interface 104 having a chatbot 106 allows communication between a user and a story generation system 102. The user interface 104 is operatively coupled to the story generation system 102. The user interface 104 allows users to collect user details 108 by utilizing the chatbot 106, using which the user interacts with the story generation system 102. The user details 108 include one or more user interests like playing cricket, dancing, singing etc., one or more user incidents like attended a rock concert, went on a beach vacation, hobbies like craft, art, and so on.

The user interface 104 serves as the heart of the artificial intelligence (AI) story generation environment 100. The user interface 104 is designed with thoughtful UI/UX (user interface/user experience) considerations to provide an intuitive and engaging story generation system 102 which can be accessed by the user to access the personalized story. Through the user interface 104, the user, for instance, a student can engage with the chatbot 106, provide personal information, select topics of interest, and interact with generated stories and comprehension assessments. Similarly, the user for instance, educators can monitor student progress, review performance metrics, and provide guidance and feedback as needed. The user interface 104 is crafted to enhance usability, accessibility, and overall user experience, facilitating seamless engagement with the story generation system 102.

The chatbot 106 serves as a gateway through which the user interacts with the story generation system 102. The chatbot 102 is equipped with natural language processing capabilities, allowing it to engage users in conversation, gather detailed information about user's interests, hobbies, and recent life incidents, and disambiguate responses to ensure accuracy. Through conversational interactions, the chatbot creates a dynamic and engaging experience, guiding users through the process of personalizing their educational journey. Moreover, the chatbot 106 adapts and learns from each interaction, continually refining its ability to understand and respond to the user's needs and preferences.

A memory 110 is operatively coupled to the user interface 104 and user details 108 received via the user interface 104 along with user's reading level value are stored in the memory 110. The user details 108 obtained through the user interface 104 are stored in user profile 112.

In an exemplary embodiment, the user's profile 112 is encapsulated within a data structure, where each key-value pair signifies a distinct attribute of the user, encompassing learning level and interests. Interests are articulated as a list, each comprising a type and value which serves as a critical component in the personalization of the story content.

The below pseudo code represents exemplary data structure of a user profile i.e. a “student profile”:

```
    {
“basic_info”: {
    “id”: “abc@xyz.com”,
    “name”: “abc”,
    “grade”: 4
},
“interests”: [
    {
    “type”: “sports”,
    “values”: [
      “cricket”,
      “football”
    ]
    }
  ],
  “personality”: “statement from student”,
  “incidents”: [
      {
      “date”: “unix-timestamp”,
      “description”: “i went to disneyland with xyz”,
      “connections”: [“xyz-friend-uuid”]
      }
  ],
  “connections”: {
    “xyz-friend-uuid” : {
      “gt_school_id”: “xyz@abc.com | None”,
      “name”: “xyz”,
      “relationship”: “friend/ brother/ father”,
      “personality”: “statement from student”
      }
  }
}
{
```

In operation 204, the story topic identifier 118 identifies at least one story topic based upon the user details 108, the reading level value of the user, and one or more educational standards 114. The one or more educational standards 114 include Common Core State Standards (CCSS), NGSS (Next Generation Science Standards) and AP. The story topic identifier 118 selects at least one topic of the story for the story generation from the user profile 112 by using the user details 108 and recent chat interaction of the user with the chatbot 106. The story topic identifier 118 identifies the story topic for the story generation by receiving one or more educational topics from one or more curriculums relevant to the user profile 112. The relevancy of curriculum is based on age or level of education of the user. The identified educational topics are then compared to the user profile 112 and recent interactions of the user with the chatbot 106. Finally, the one or more educational topics that match the user profile 112 are extracted. The story topic identifier 118 then incorporates an algorithm for selecting at least one story topic for the story generation from the user profile 112 in order to prioritize one or more interests and one or more incidents extracted from the recent chat interaction of the user and the chatbot 106 over those stored in the user profile 112 for increased relevance.

The below pseudo code represents exemplary data structure of “generation of topic for story generation”:

```
{
  “domain”: “string”,
  “cluster”: “string”,
  “standard (this is the learning objective)”: “string”,
  “clarification statement”: “string”,
  “assessment boundary”: “string”,
  “grade level”: “string”
}
```

The reading level value of the user is an essential parameter in the personalized learning experience facilitated by the artificial intelligence (AI) story generation environment 100. The reading level value quantifies the reading comprehension level of the individual user, allowing the AI story generation system 116 to adjust the complexity of generated stories accordingly. The reading level value adjustment module 126 operatively coupled to the story generator 120 assigns the default reading level value to the user profile 112 by evaluating reading ability of the user using one or more reading level assessment tools. Exemplary reading ability assessment tools may include Schonell Reading Test, MacMillian Reading Level Test, and other suitable reading level assessment tests. The AI story generation system 116 provides an iterative reading level adjustment process which fine-tunes the complexity of stories to match the user's reading ability, promoting gradual skill development and academic growth. This personalized approach to content delivery optimizes learning outcomes by catering to each user's unique cognitive capabilities and literacy skills.

The story topic identifier 118 serves as a crucial component in generating at least one topic for the story generation. The story topic identifier 118 systematically analyzes user's indicated one or more interests, one or more life incidents, user's reading level value, one or more educational standards 114 and selects relevant topics for story generation. By leveraging natural language processing techniques, the story topic identifier 118 identifies key themes, concepts, and subject areas that align with user's preferences and curriculum objectives which ensures that the generated stories are not only engaging but also educationally relevant, fostering deeper comprehension and retention of the material. The story topic identifier 118 is further configured to provide a preference order which is dynamically adjusted based on the relevance of one or more incidents with the selected topic, with one or more incidents closely aligned with the subject matter being assigned higher priority over those with unrelated themes.

In operation 206, a story generator 120 operatively coupled to the AI story generation system 116 automatically generates the story based upon the topic selected by the story topic identifier 118. The story generator 120 incorporates one or more AI engines to generate the story. The story generator 120 integrates one or more artificial intelligence (AI) tools, harnessing the power of advanced algorithms and natural language processing capabilities to generate rich and engaging narratives. By employing AI engines, the story generator 120 is equipped to analyze user details 108 and generate a story, which captivates and educates the user. This symbiotic relationship between the story generator 102 and the AI story generation system 116 underscores its ability to deliver personalized learning experiences that adapt to the unique needs and interests of each user.

The AI engines used in the AI story generation environment 100 uses a Large Language Model (LLM) which is trained to perform within a set of guidelines to generate a factually right and interesting story. The LLM is configured to generate a personalized story using prompt engineering and prompt chaining techniques. The LLM used here is GPT LLM and framework for generative artificial intelligence available from OpenAI having an office in San Francisco, CA. Although other suitable LLMs can be used.

Prompt engineering involves the strategic design of prompts or input stimuli to guide the AI story generation environment 100 towards generating desired outputs. By carefully crafting prompts that incorporate key elements such as one or more user interests, educational topics, and contextual information, prompt engineering directs the LLM towards producing narratives that are tailored to the individual user's preferences and learning objectives. The prompt engineering technique ensures that the generated stories are not only relevant and engaging but also aligned with educational standards and curriculum guidelines. Furthermore, prompt chaining involves the sequential presentation of prompts to the LLM, allowing for the generation of coherent and cohesive storylines. Through prompt chaining, the LLM can build upon previous prompts and responses, creating narratives that unfold dynamically and fluidly. This technique enables the LLM to incorporate user input, refine story details, and maintain consistency throughout the storytelling process.

In operation 208, a content identifier 122 identifies the user details to be used in the story which includes one or more characters of the story and user details 108 of the user obtained from the user interaction with the chatbot 106 and user profile 112.

A content generator 124 generates a story based on the identified user details and the default reading level value of the user. The content generator 124 adheres to a set of guidelines which include some rules that serve as foundational principles for crafting engaging and effective narratives. Firstly, metaphors related to the reader's interests are utilized to impart educational topics, ensuring relevance and resonance with the user. Secondly, the prompt assumes familiarity with character backgrounds and topics of interest, avoiding unnecessary explanations to maintain narrative flow. Thirdly, stories are intricately woven with the chosen topic, delving into its nuances on a deeper level to enhance comprehension. Fourthly, factual accuracy within the story context is paramount, fostering trust and credibility with the reader. Additionally, stories are structured to comprehensively and clearly teach the required topic, promoting understanding and retention. Furthermore, characters, including the student and their friends, are incorporated into the narrative, fostering relatability and immersion. The tone of the story remains conversational, avoiding a preachy demeanor that may alienate the audience. Moreover, story length is optimized to around 500 words, maintaining reader engagement while conveying necessary information concisely. Finally, long preambles and epilogues are avoided, ensuring a focused narrative that efficiently delivers educational content. Despite these constraints, stories exceed a minimum length of 350 words, striking a balance between brevity and substance.

In operation 210, a reading level value adjustment module 126 converges the reading level value of the story with the user's reading level value based on an iterative reading level value adjustment process. The reading level value adjustment module 126 divides the broad range of reading level values into distinct reading level buckets and comparing the default reading level value to reading level buckets thereby adjusting the complexity of the generated story according to the relevancy of the user reading level value to corresponding reading level bucket

The reading level value adjustment module 126 utilizes a sophisticated iterative process which dynamically adjusts the reading level value of the story generated based on the user's indicated reading level and comprehension abilities. The reading level value adjustment module 126 is fine-tuned by the complexity of the stories which in turn ensures that users are appropriately challenged while avoiding frustration or boredom. This personalized approach to content delivery enhances comprehension and promotes skill development, contributing to more effective and enjoyable learning experiences.

In operation 212, the user interface 104 operatively coupled to the story generation system 102 displays the generated story. The user interface 104 seamlessly displays the generated story upon completion of the story generation process, providing users with immediate access to the story. This ensures a user-friendly and intuitive experience, allowing users to engage with the generated stories effortlessly. Through the user interface 104, users can explore the rich narrative elements and educational content presented to them, interacting with the story in a visually engaging and immersive manner. Additionally, the user interface 104 may incorporate features such as navigation controls, interactive elements, and feedback mechanisms to enhance user engagement and facilitate ease of use.

In operation 214, a MCQ generator 128 generates multiple-choice questions (MCQs) based on the generated story for assessing reading capabilities of the user. The reading level value of the user is updated based on the response of the user to the MCQs. For example, if the user gives all the answers correctly, the reading level value of the user will be raised and from next time the story generated will be of a higher level and vice versa. The MCQ generator 128 is further configured to dynamically adjust the difficulty level of the generated MCQs in real time based on the user's performance history in order to provide an adaptive assessment experience to the user.

A feedback module 130 is operatively coupled to the MCQ generator 128 and chatbot 106. The feedback module 130 allows users to provide feedback on the generated personalized stories for continuous improvement in real time. For example, if the user is not able to understand the generated story or wants change in the event or any character and so on. Then the user can directly instruct the chatbot 106 about his/her preferences and interests and based on this the story generator 120 will make the changes and generate a new story in real time.

The artificial intelligence (AI) story generation environment 100 utilizes sophisticated AI technology to generate a story that aligns with each user's individual interests, hobbies, and life experiences. This personalized approach not only fosters greater engagement and motivation but also promotes deeper comprehension and retention of key concepts. Additionally, one or more educational standards 114 integrated to the content ensures that the content meets curriculum requirements, providing educators with a valuable tool for supplementing classroom instruction and reinforcing learning objectives. Furthermore, the artificial intelligence (AI) story generation environment has 100 adaptive nature, including the iterative reading level adjustment process, ensures that the complexity of the material is appropriately calibrated to each user's reading level, accommodating diverse learning needs and facilitating gradual skill development. Moreover, the interactive chatbot 106 and user-friendly story generation system 102 foster active participation and feedback, empowering users to take ownership of their learning journey.

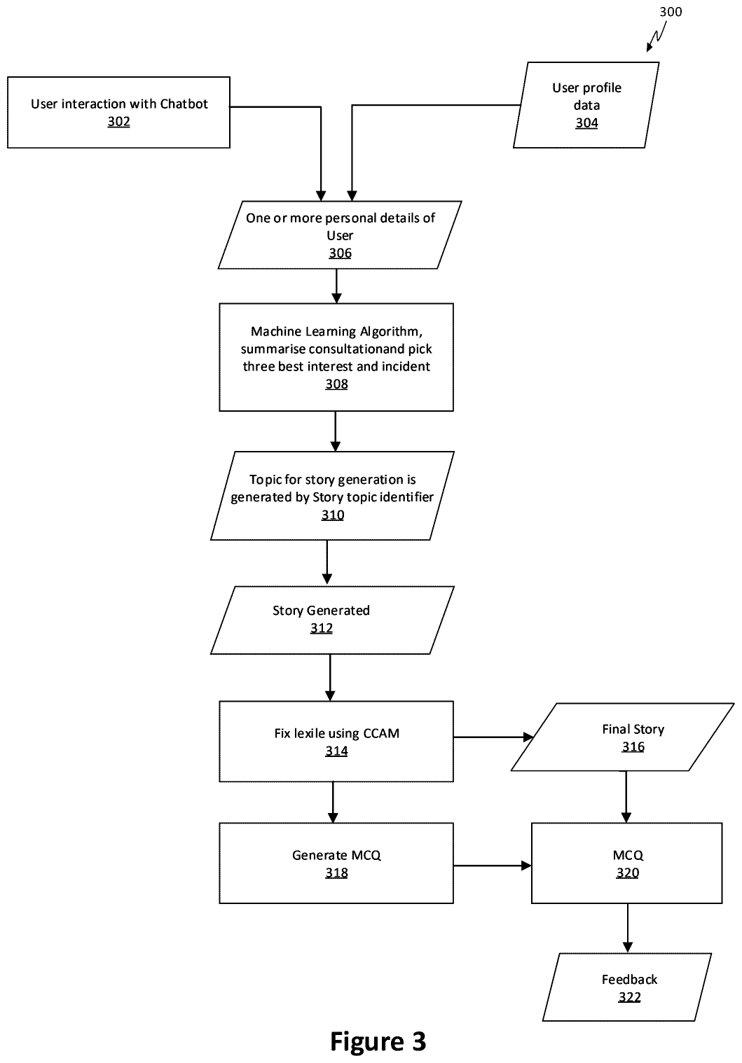

FIG. 3 depicts a flow diagram 300 showing details of steps involved in the story generation process.

The details obtained through the interaction of the user with the chatbot 302 and the details obtained from the user profile 304 are represented as user details of the user 306. The user provides input to the story generation system 102 through the chatbot 106 in the form of pseudo code given below:

The below prompt represents an exemplary structured AI story generation prompt for guiding and constraining story generation by the artificial intelligence (AI) story generation environment 100:

```
            # Import necessary libraries for LLMs, chatbot
functionality, and reading level adjustment
        import large_language_model_library
        import chatbot_library
        import reading level_adjustment_library
        # Define the main function to run the personalized story
generation tool
        def personalized_story_generation_tool(student_profile,
educational_topic):
          ″″″
          Main function to generate a personalized story based on the
student's Reading level level,
          interests, and educational topic.
          ″″″
          # Step 1: Capture student interests using the chatbot
          student_interests = chatbot_conversation(student_profile)
          # Step 2: Select the best interest related to the educational
topic
          selected_interest = select_best_interest(student_interests,
educational_topic)
          # Step 3: Generate an initial story draft using the selected
interest and LLM
          initial_story = generate_initial_story(selected_interest,
educational_topic)
          # Step 4: Iteratively adjust the story's reading level level
to match the student's reading ability
        final_story = iterative_reading
level_adjustment(initial_story, student_profile[‘reading level_level’])
          # Step 5: Generate MCQs based on the final story content
          mcqs = generate_mcqs(final_story)
          # Return the final personalized story and MCQs
          return_final_story, mcqs
      # Define the chatbot conversation function
      def chatbot_conversation(student_profile):
          ″″″
          Engages the student in a conversation to extract interests
and other relevant information.
          ″″″
          # Initialize the chatbot
          chatbot = chatbot_library.initialize_chatbot( )
          # Start conversation and capture interests
          interests = chatbot.extract_interests(student_profile)
          return interests
      # Define the function to select the best interest
      def select_best_interest(interests, educational_topic):
          ″″″
          Selects the most relevant interest from the student's profile
for story personalization.
          ″″″
          # Algorithm to match interests with the educational topic
          best_interest =
large_language_model_library.match_interest_with_topic(interests,
educational_topic)
          return best_interest
      # Define the function to generate the initial story
      def generate_initial_story(interest, educational_topic):
          ″″″
          Generates an initial story draft using LLM based on the
selected interest and educational topic.
          ″″″
          # Use LLM to create a story draft
          story = large_language_model_library.create_story(interest,
educational_topic)
          return story
      # Define the iterative reading level adjustment function
      def iterative_reading level_adjustment(story, target_reading
level_level):
          ″″″
          Iteratively adjusts the reading level level of the story to
match the student's reading ability.
          ″″″
          # Use the reading level adjustment library to iteratively
adjust the story's reading level level
          adjusted_story = reading
level_adjustment_library.iterative_adjustment(story, target_reading
level_level)
          return adjusted_story
      # Define the function to generate MCQs
      def generate_mcqs(story):
          ″″″
          Generates multiple-choice questions based on the content of
the final story.
          ″″″
          # Use LLM to create MCQs related to the story
          mcqs = large_language_model_library.create_mcqs(story)
          return mcqs
      # Example usage of the tool
      student_profile = {
          ‘name’: ‘John Doe’,
          ‘reading level_level’: 850,
          ‘interests’: [‘space’, ‘sports’, ‘music’]
      }
      educational topic = ‘gravity’
      final_story, mcqs =
personalized_story_generation_tool(student_profile, educational_topic)
```

The machine learning algorithm utilizes the user details of the user 306 and summarizes the interaction of the user through chatbot 302 and the details obtained from the user profile 304 to pick the top three best interests and incidents 308 from the user's profile. Based on the top three best interests and incidents 308, the story topic identifier 118 generates a story 312. The summary of the conversation obtained by the chat interaction between the user and the story generation system 102 via chatbot 106 includes:

### “Summary of Recent Conversation

Aman recently enjoyed his visit to Montreal due to its cultural mix and he particularly loved the cheese . . . ”

```
      {
        “name”: “Aman”,
        “incidents”: [
            {
            “date”: “unknown”,
            “description”: “i went on a trip to kodaikanal and did a
trek in dolphin's nose”
            }
        ],
        “interests”: [
            {
            “key”: “interests”,
            “values”: [
              “robotics”,
            “aerial robotics”,
              “coding“
            ]
            }
        ],
        “personality”: “”,
        “connections”: {
            “1”: {
            “name”: “Arpit”,
            “relationship”: “Friend”,
            “personality”: “”
            },
            “2”: {
            “name”: “Nic”,
            “relationship”: “Friend”,
            “personality”: “very proactive”
            }
        }
      }
```

Exemplary input for the topic generation prompt using story topic identifier 310 is given below:

```
{
        “subject”: “Science”,
        “grade”: “3”,
        “domain”: “Earth and Space Science”,
        “cluster”: “Earth and Human Activity”,
        “standard_description”: “Make a claim about the merit of a
design solution that reduces the impacts of a weather-related
hazard.*”,
        “std_id”: “3-ESS3-1“ [COMMENT: “std_id” represents the COMMON
CORE CURRICULUM standard identifier]
      }
```

The reading level value score of the user is defined as:

“Reading level
1400”

A reading level value adjustment module 126 converges the reading level value of the story 314 with the user's reading level value based on an iterative reading level value adjustment process. Finally, a story generator 120 generates the final personalized story 316 for the user. The final personalized story 316 generated by the story generator 120 is given below:

### “Story

Shielding the Dolphin's Nose
Aman was savoring the last piece of Montreal cheese, his mind wandering back to his recent trip. That cheese always had a way to spark creative thoughts. As he digested the intricate mix of cultures he encountered in Montreal, his mind slowly drifted to another place close to his heart, the Dolphin's Nose-a famous trekking spot in Kodaikanal.
He remembered the last time he, Arpit, and Nic did the trek and how they barely managed to escape from a sudden storm. Even though it was an adventure, the risks dawned upon them later. They were lucky to escape, but what if other trekking enthusiasts were not? They needed a solution.
The next day, Aman shared his thoughts with Arpit and Nic. The pro-active Nic immediately suggested, ‘How about devising a system to dodge the unpredictable weather up there?’
Aman, intrigued, asked, ‘A system like a weather station?’ Nic nodded, eyes gleaming.
The trio finalized a design that consisted of an anemometer to measure wind speed, a barometer to measure atmospheric pressure, and a rain gauge for precipitation. Based on these data, they hoped to predict upcoming storms.
In the following weeks, their weather station was installed near the beginning of the Dolphin's Nose trail. The station was connected to a digital board that displayed warnings for trekkers. If a weather threat was detected, a symbol of a dolphin's nose enveloped in a storm cloud would flash, signaling the trekkers to halt their journey and return to safety.
As days passed, the feedback from fellow trekkers was encouraging. Incidents of unwitting folks getting caught in the unpredictable weather reduced significantly.
In this process, not only did Aman, Arpit, and Nic apply their interests and knowledge to help others but they also fostered an appreciable link between man and nature. Eventually, they realized how aligning their passion for trekking with understanding of earth science could potentially save lives.
Sometimes it takes an adventure, some Montreal cheese, and most importantly, a motivation to make a difference, to bring forth solutions that can stand the test of time . . . and storms.”

An AI multiple choice question (MCQ) generator 128 generates 318 a set of multiple-choice questions (MCQs) 320 which are related to the story. The multiple-choice questions (MCQs) 320 helps in determining the understanding level of the user and update the reading level value of the user based on the response of the user. An exemplary prompt to guide and constrain the AI MCQ generator 128 for the generated set of multiple-choice questions (MCQs) 320 is given below:

```
MCQs
[
  {
    “options”: [
      “To track the movements of wild animals”,
      “To alert trekkers about upcoming storms”,
            “To measure the intensity of storms for research purposes”,
            “To improve internet connection in the area“
            ],
            “ques”: “What was the purpose of the system developed by
Aman, Arpit, and Nic?”,
            “ans”: “1“
        },
        {
          “options”: [
            “Thermometer, Barometer, Seismometer”,
            “Anemometer, Barometer, Rain gauge”,
            “Thermometer, Anemometer, Rain gauge”,
            “Rain gauge, Barometer, Humidity sensor”
            ],
            “ques”: “What were the components of the weather station
that the trio devised?”,
            “ans”: “1”
        },
        {
          “options”: [
            “A lightning bolt”,
            “A rain cloud”,
            “A dolphin's nose enveloped in a storm cloud”,
            “A trekker running away”
            ],
            “ques”: “Once the weather station was operational, what
symbol would flash on the digital board as a warning sign?”,
            “ans”: “2”
        }
      ]
```

A feedback generator 130 allows users to provide feedback 322 on the generated personalized stories for continuous improvement.

Another example of story generation process 200 utilized by the artificial intelligence (AI) story generation environment 100 is shown below:

The user provides input to the story generation system 102 through the chatbot 106, and the chatbot 106 converts the input into structured data as, for example, given below:

```
            {
        “name”:“Nicholas Engelbert”,
        “incidents”:[
            {
            “date”: “unknown”,
            “description”: “I got bullied in school'”
            }
        ],
        “interests”:[
            {
              “key”:“Hobbies and crafts”,
              “values”:[
                “Origami”,
                “Crochet”
            ]
            }
        ],
        “personality”:“social outcast, doesn't have any friends,
depressed and lonely”,
        “connections”:{
              }
      }
```

The summary of the conversation obtained by the chat interaction between the user and the story generation system 102 via chatbot 106 includes:

“Summary of Recent Conversation
Nicholas is currently under extreme emotional distress due to bullying at school and expresses feelings of isolation and despair.”

Exemplary structured input data for the topic generation using story topic identifier 310 is given below:

```
    {
        “subject”: “World History”,
        “grade”: “AP”,
        “domain”: “Global Conflict”,
        “cluster”: “Mass Atrocities After 1900”,
        “standard_description”: “The rise of extremist groups in power
led to the attempted destruction of specific populations, notably the
Nazi killing of the Jews in the Holocaust during World War II, and to
other atrocities, acts of genocide, or ethnic violence.”,
        “std_id”: “KC-6.2.III.C”
      }
```

The reading level value score of the user is defined as:

“Reading level
1200”

The final personalized story generated 316 by the story generator 120 based on the above provided pseudo codes and user details is given below:

### “Story

The Shadows of History
Nicholas Engelbert had grown used to the chill of the school corridors, to the distant laughter and the isolation it cocooned him in. He often found solace in his history textbooks, to a time and place that spared him of his gloomy present. The bullying had become a daily affair for him, much like the pages of World History he delved into every evening. This very evening, however, he found an uncanny mirror to his circumstances in a chapter titled ‘Mass Atrocities After 1900.’
As he turned the pages, with every word he read, he found the echoes of his own life. The rise of extremist groups during World War II resonated strongly with him. He likened the school bullies to these extremists, perceiving their hunger for power and their tactics to instill fear to be similar. The extermination of specific racial groups, particularly the Jews during the Holocaust, stirred a feeling of empathy, as he too felt targeted and threatened in his lonesome world.
Just like the Nazis, the bullies in school played on his vulnerabilities. The same skewed sense of superiority that the Nazis believed in was reflected in the actions of his tormentors. They thrived on Nicholas's misery, in the same way, that the Nazis thrived on the torment and ultimate destruction of the Jewish populace.
In drawing these parallels, Nicholas not only found an understanding of the rise and fall of extremist groups during World War II, but also an eerie similarity of the same in his microcosm. He often visualized himself, not as a frail teenager against the bullies, but as the victimized population during the Holocaust. It helped him understand the brutal face of power, manipulation, and devastation of innocents.
On more hopeful days, Nicholas found comfort in the stories of resistance and survival. Those who braved the grotesque atrocities and lived to tell the tale, their tales kindled a flicker of hope within him. Just like these people, he too, he thought, had the strength inside of him to withstand the psychological brutality hurled at him every day.
The historical remnants of the past inevitably juxtaposed with Nicholas's reality. While heart-wrenching, these stories from the past were also a source of solace, strength, and in ways, an escape from his own grim reality. He found parallels in history that were too real to be mere coincidences and they taught him more about his own life than about the past.
Nicholas understood that history was a relentless cycle, and he had found solace in the knowledge that it was his will to endure that held power over the contemporaneous forces. History had indeed become Nicholas's companion. As for the bullies, they too were a part of history, not realizing the irony, that they were inadvertently enabling Nicholas to unravel profound realities of the past along with the resilience to declare, ‘I shall not be destroyed.’”

The pseudo codes for multiple choice questions generated 320 once the user has gone through the generated story 316 includes:

```
    MCQs
    [
      {
          “options”:[
          “It is very friendly and supportive.”,
          “He is bullied on a daily basis.”,
          “He is a popular student in his school.”,
          “He is indifferent to his school environment.”
          ],
          “ques”:“What is the school environment like for Nicholas
Engelbert?”,
          “ans”:“1”
      } ,
      {
          “options”:[
          “He compares the bullies to the extremist groups in World
War II.”,
          “He relates his situation to the Industrial Revolution.”,
          “He compares himself to the winners of World War II.”,
          “He finds no relation between his situation and the events
described in his history textbook. ”
          ],
          “ques”:“How does Nicholas relate his situation to the events
in his history textbook?”,
          “ans”:“0”
      },
      {
          “options”:[
          “He understands that history tends to repeat itself.”,
          “He learns to appreciate the good times more.”
          “He takes comfort in knowing that he too can survive the
psychological brutality he faces.”,
          “He comprehends the injustice done to the victims but takes
no personal message from it.”
          ],
          “ques”:“What does Nicholas learn from the stories of
survival during times of mass atrocities?”,
          “ans”:“2”
      }
    ]
```

Based on the answers provided by the user the feedback is generated 322 using which the reading level value of the user is updated in real time.

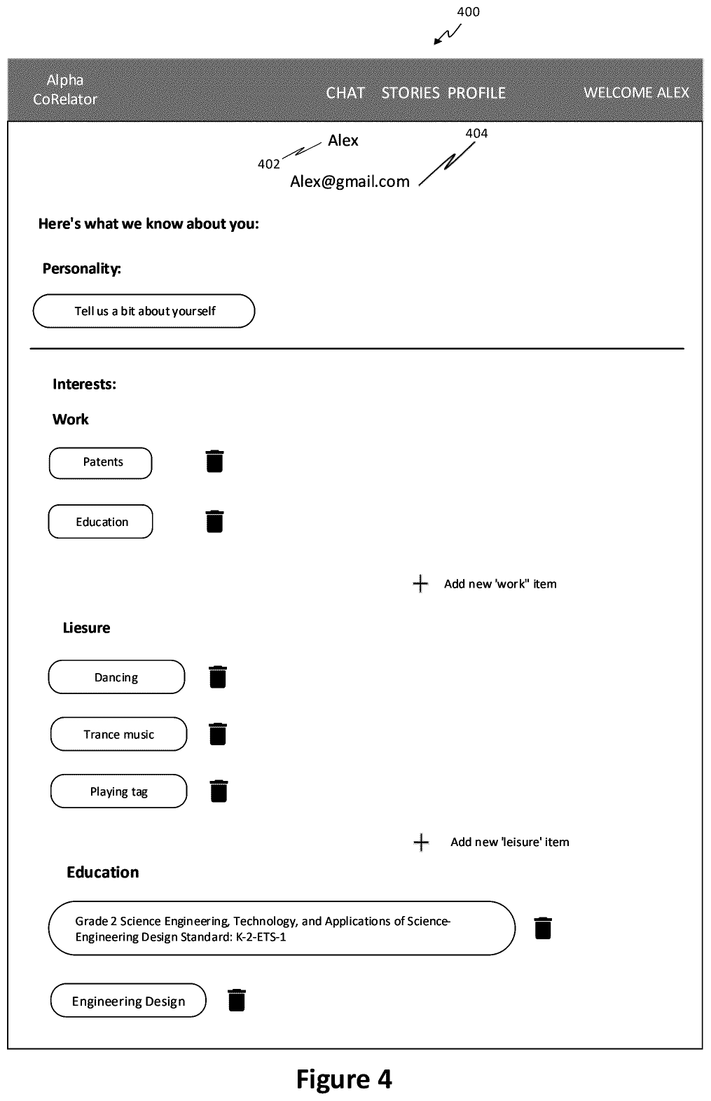

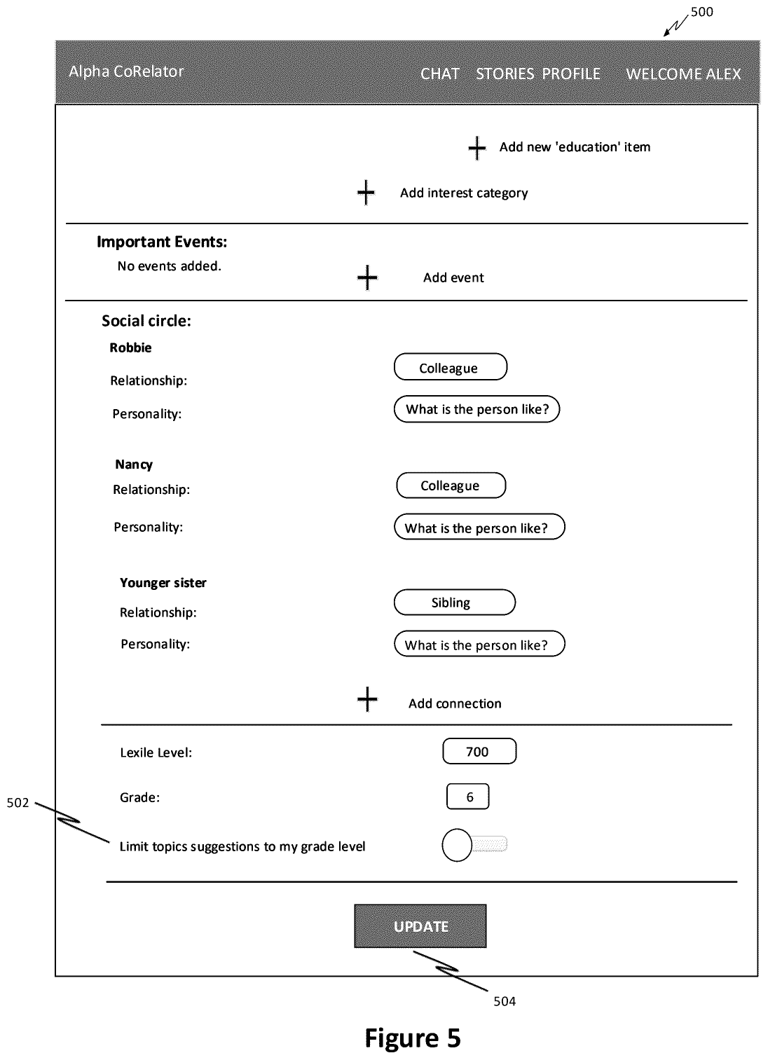

FIGS. 4-5 depict user interfaces 400 and 500 displaying details stored in an exemplary user profile.

The user interface 400 includes a tab 402 mentioning user name and another tab 404 showing user's email id. Other details shown in the user interface 400 include ‘personality’, ‘interests’ and ‘education’ related details of the user.

The user interface 500 includes the details of ‘important events’, ‘social circle’, ‘reading level value’ and ‘grade’ of the user. The user interface 500 also allows the user to limit the topic suggestions 502 to their level of education or grade. Finally, the user can click on the tab 504 ‘update’ to update the user profile.

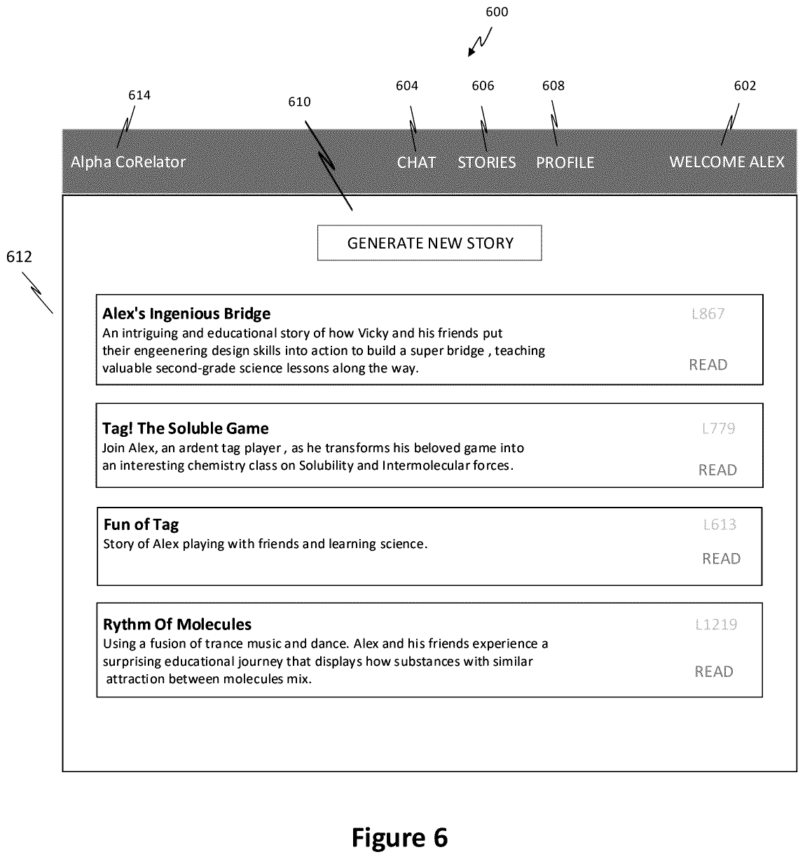

FIG. 6 depicts a user interface 600 displaying exemplary dashboard of the exemplary story generation system 102.

The dashboard 600 is accessed by the user through the story generation system 102 which is operatively coupled to the AI story generation system 116. The dashboard 600 includes tab 602 representing user id i.e., ‘Alex’ in this exemplary scenario. On clicking the tab 604, the user gets access to the chatbot 106 using which the users can interact with the story generation system 102. Further, on clicking the tabs 606 and 608 the user can access the stories generated till date by the story generator 120 and the user profile 112, respectively. Tab 614 represents the name of the story generation system 102 i.e., Alpha Correlator.

On clicking the tab 610, the user can generate new stories based on the interaction between the user and the chatbot 106, reading level value of the user and the one or more educational standards 114. Section 612 shows different stories generated by the story generator 122 till date. Each of the generated stories is shown in a tile format including brief text providing details of the story and a button ‘READ’ to click and read the story.

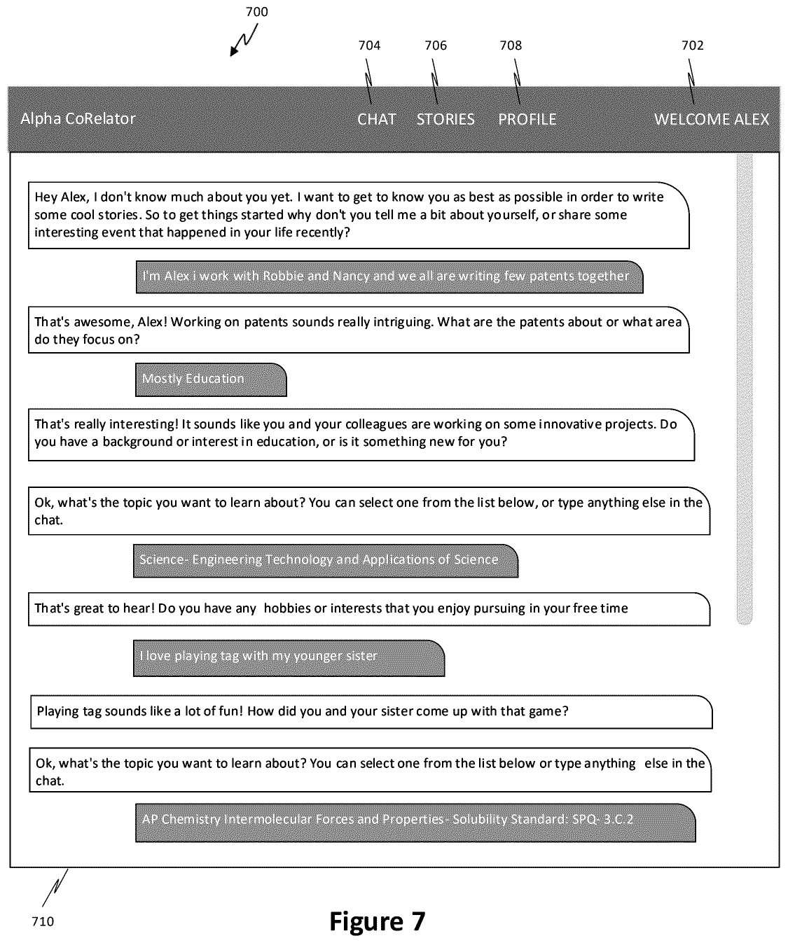

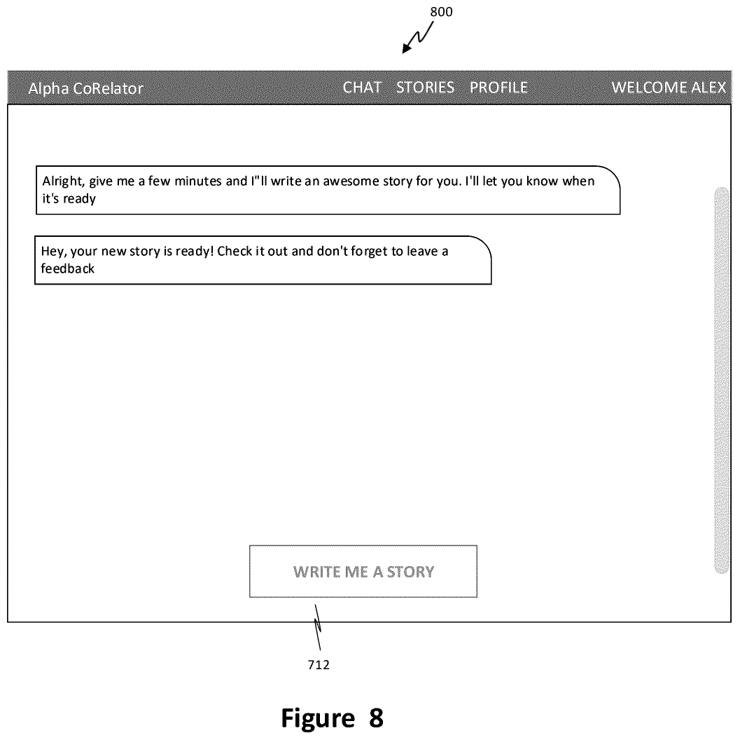

FIGS. 7-8 depict exemplary views 700 and 800 of a user interface where a user interacts with the story generation system via a chatbot for story generation.

The user interfaces 700 and 800 shown here represents a chatbot 106 using which the user interacts with the story generation system 102. The user interfaces 700 and 800 are accessed by the user through a story generation system 102 which is operatively coupled to the AI story generation system 116. The user interface 700 and 800 includes tab 702 which represents user id i.e., ‘Alex’ in this exemplary scenario. On clicking the tab 704, the user gets access to the chatbot 106 using which the users can interact with the story generation system 102. Further, on clicking the tabs 706 and 708 the user can access the stories generated till date by the story generator 120 and the user profile 112 respectively.

The section 710 represents the chat interaction between the user and the story generation system 102. Based on the interaction between the user and the story generation system 102, the story topic identifier 118 selects at least one topic for the story generation either manually by the user or automatically based on the interaction. Finally, on clicking the tab 712 ‘Write Me A Story’ a story is generated and once the story is generated, the user can click on the tab 714 ‘Read’ to read the generated story which will be generated on the user interface 104 of the story generation system 102.

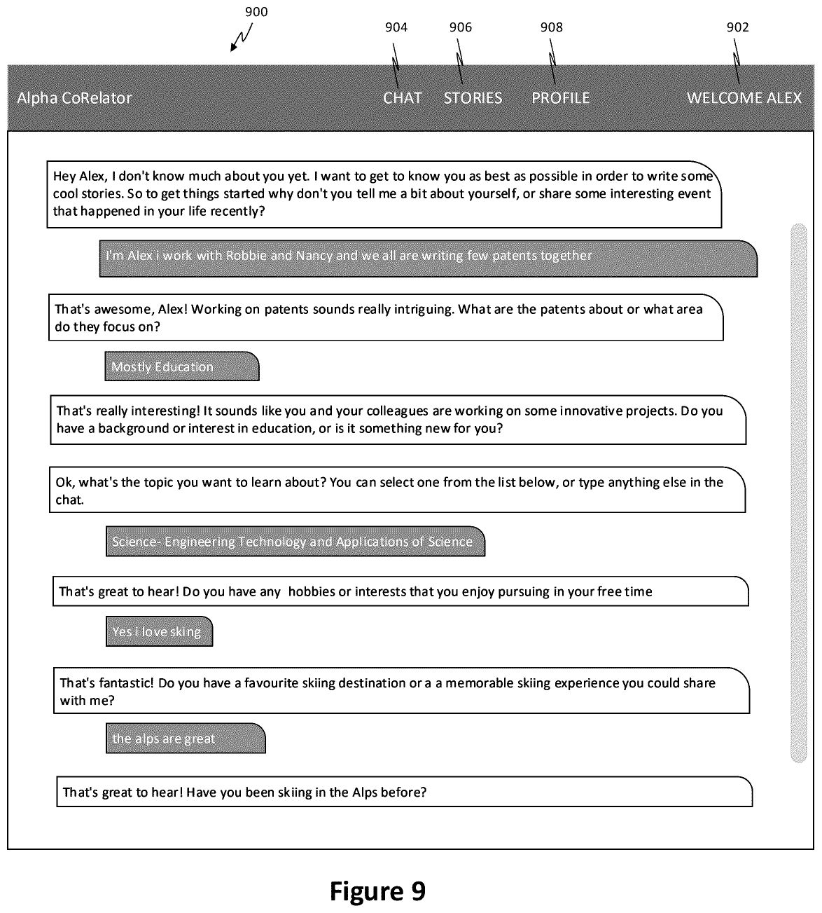

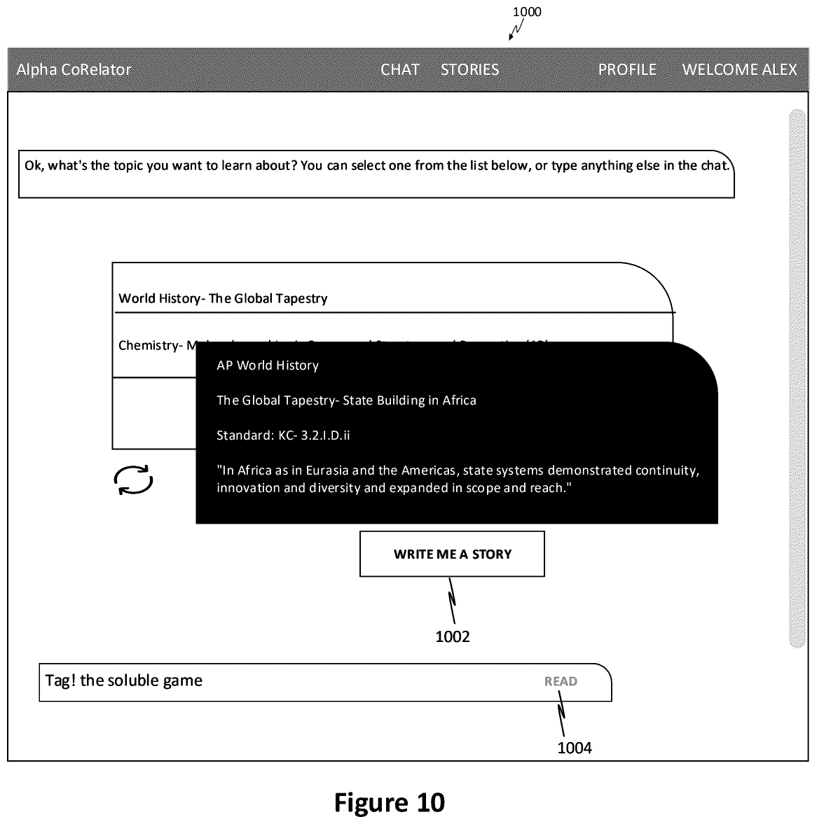

FIGS. 9 and 10 depict an exemplary view of a user interface 900 and 1000 providing options to the user for selection of topic of his/her choice for story generation.

The user interface 900 shown here represents a chatbot 106 using which the user interacts with the story generation system 102. The user interface 900 is accessed by the user through a story generation system 102 which is operatively coupled to the AI story generation system 116. The user interface 900 includes tab 902 which represents user id i.e., ‘Alex’ in this exemplary scenario. On clicking the tab 904, the user gets access to the chatbot 106 using which the users can interact with the story generation system 102. Further, on clicking the tabs 906 and 908 the user can access the stories generated till date by the story generator 120 and the user profile 112 respectively.

The section 910 represents the chat interaction between the user and the story generation system 102. Based on the interaction between the user and the story generation system 102, the story topic identifier 118 selects at least one topic for the story generation either manually by the user or automatically based on the interaction.

In case of FIG. 9, the story topic identifier 118 identifies at least one topic of interest for story generation based on the user details 108, the reading level value of the user and one or more educational standards 114. Based on the chat interaction of the user with the story generation system 102, the story topic identifier 118 analyzes the chat and creates topics for story generation which is related to the user's educational standard 114. For example, in this case, based on the chat interaction of the user with the story generation system 102, the topic generated by the story topic identifier 118 is ‘AP Chemistry intermolecular forces and properties-solubility standard’. Here, the user can also enter a topic of his choice through the chatbot 106. On clicking the tab 912 ‘Write Me A Story’ a story is generated and once the story is generated, the user can click on the tab 914 ‘Read’ to read the generated story which will be generated on the user interface 104 of the story generation system 102.

In case of FIG. 10, the story topic identifier 118 analyzes the chat interaction of the user with the story generation system 102 and on the basis of that determines some exemplary topics for story generation which are related to the user's educational standard 114. For example, in this case, based on the chat interaction of the user with the story generation system 102, the topics generated by the story topic identifier 118 are ‘World History—The Global Tapestry’, ‘Chemistry—Molecular and Ionic Compound Structure and Properties’, ‘Math's—The Number System’, ‘Social Studies-International Developments in the Post World War II World’ and so on. The user can select any topic of his choice and click on the tab 1002 ‘Write Me A Story’ to generate a story and once the story is generated, the user can click on the tab 1004 ‘Read’ to read the generated story which will be generated on the user interface 104 of the story generation system 102.

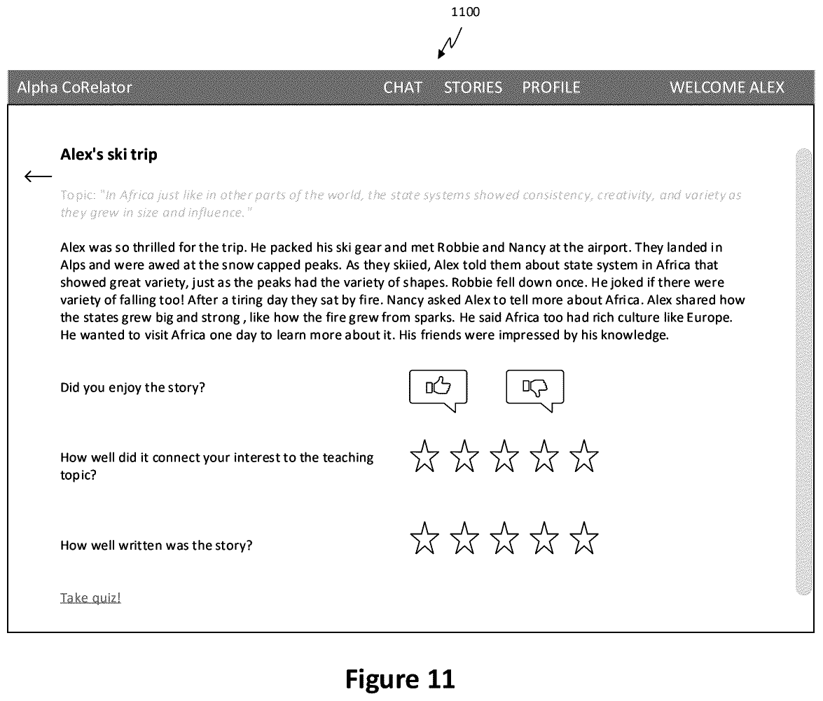

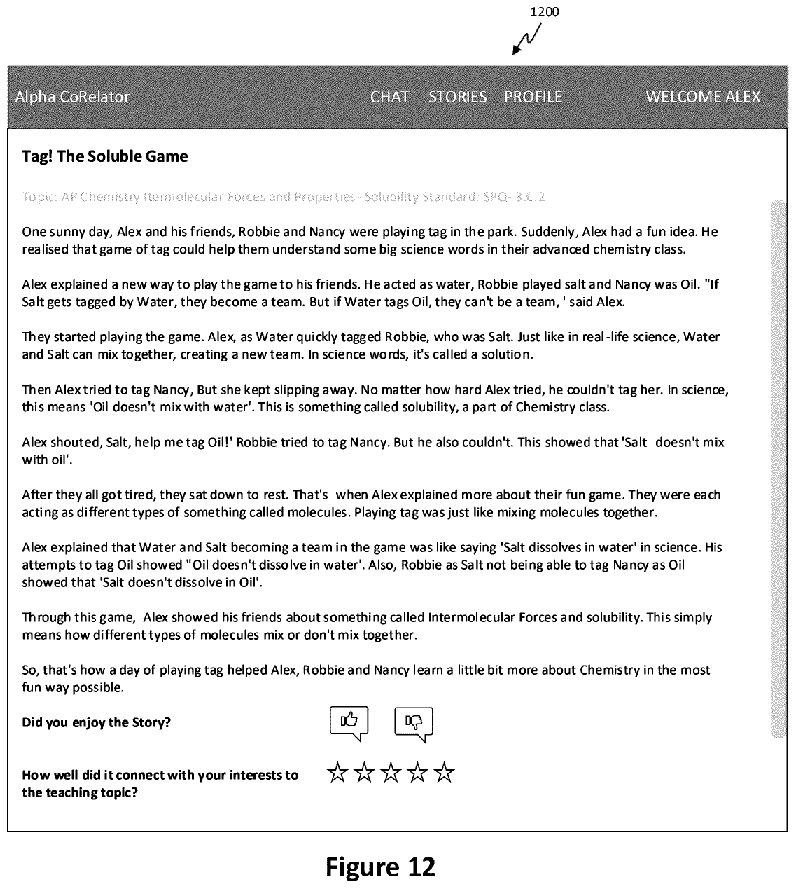

FIGS. 11-12 depict exemplary stories generated by the story generation process 200 of FIG. 2.

The final personalized stories 1100 and 1200 generated by the story generator 120, operatively coupled to the AI story generation system 116, represents the culmination of a sophisticated artificial intelligence (AI) story generation process 200 designed to engage and educate users effectively. The chatbot 106 utilizes the wealth of user details 108, including interests, hobbies, and life incidents collected through interactive chatbot interactions. The story generator 120 crafts a narrative tailored specifically to each user's unique profile 112. Furthermore, the AI story generation system 116 incorporates one or more educational standards 114 such as the Common Core State Standards (CCSS) and the Next Generation Science Standards (NGSS), ensuring that the content aligns with established curriculum guidelines.

The user interface 104 displays the final personalized story generated using the story generator 120 and represents a convergence of user details 108, one or more educational standards 114, and reading level value of the user. Here, users can interact with the story, exploring its rich narrative elements and educational content in a visually engaging and user-friendly environment. The user interface 104 presents the story within the familiar interface of the story generation system 102, users are encouraged to actively participate in the learning process, fostering deeper engagement and retention of the material.

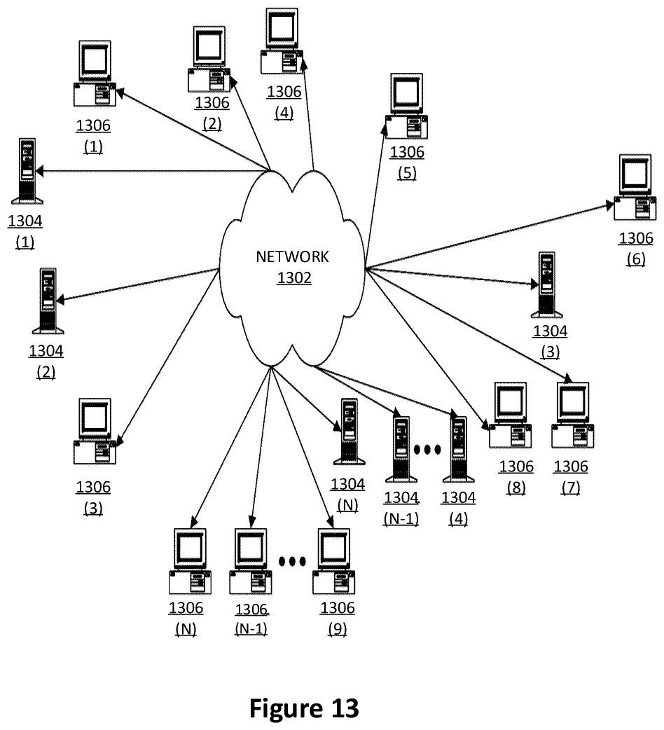

FIG. 13 is a block diagram illustrating a network environment in which the artificial intelligence (AI) story generation environment 100 and process 200 may be practiced. Network 1302 (e.g. a private wide area network (WAN) or the Internet) includes a number of networked server computer systems 1304(1)-(N) that are accessible by client computer systems 1306(1)-(N), where N is the number of server computer systems connected to the network. Communication between client computer systems 1306(1)-(N) and server computer systems 1304(1)-(N) typically occurs over a network, such as a public switched telephone network over asynchronous digital subscriber line (ADSL) telephone lines or high-bandwidth trunks, for example communications channels providing T1 or OC3 service. Client computer systems 1306(1)-(N) typically access server computer systems 1304(1)-(N) through a service provider, such as an internet service provider (“ISP”) by executing application specific software, commonly referred to as a browser, on one of client computer systems 1306(1)-(N).

Client computer systems 1306(1)-(N) and/or server computer systems 1304(1)-(N) are specialized computers programmed to improve conventional computer systems to implement and utilize the artificial intelligence (AI) story generation environment 100 and process 200. The type of computer system that can be specially programmed to implement and utilize the artificial intelligence (AI) story generation environment 100 and process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the artificial intelligence (AI) story generation environment 100 and process 200 can be implemented using code stored in a tangible, non-transient computer readable medium and executed by one or more processors. In at least one embodiment, the artificial intelligence (AI) story generation environment 100 and process 200 can be implemented completely in hardware using, for example, logic circuits and other circuits including field programmable gate arrays.

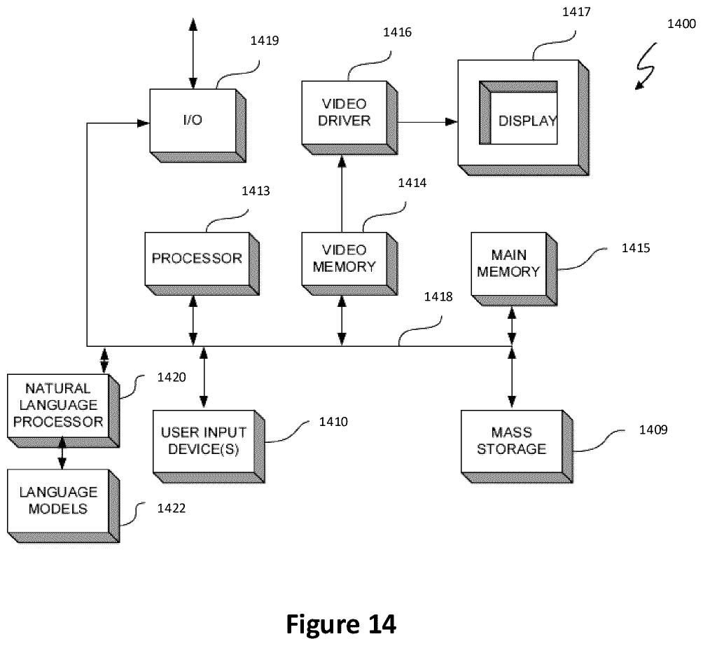

Embodiments of the artificial intelligence (AI) story generation environment 100 and process 200 can be implemented on a computer system such as a special-purpose, special-programmed computer 1400 illustrated in FIG. 14. Input user device(s) 1410, such as a keyboard and/or mouse, are coupled to a bi-directional system bus 1418. The input user device(s) 1410 are for introducing user input to the computer system and communicating that user input to processor 1413. The computer system of FIG. 14 generally also includes a non-transitory video memory 1414, non-transitory main memory 1415, and non-transitory mass storage 1409, all coupled to bi-directional system bus 1418 along with input user device(s) 1410 and processor 1413. The mass storage 1409 may include both fixed and removable media, such as a hard drive, one or more CDs or DVDs, solid state memory including flash memory, and other available mass storage technology. Bus 1418 may contain, for example, 32 of 64 address lines for addressing video memory 1414 or main memory 1415. The system bus 1418 also includes, for example, an n-bit data bus for transferring DATA between and among the components, such as CPU 1309, main memory 1415, video memory 1414 and mass storage 1409, where “n” is, for example, 32 or 64. Alternatively, multiplex data/address lines may be used instead of separate data and address lines.

I/O device(s) 1419 may provide connections to peripheral devices, such as a printer, and may also provide a direct connection to a remote server computer system via a telephone link or to the Internet via an ISP. I/O device(s) 1419 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1409, into main memory 1415 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1413, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1415 is comprised of dynamic random-access memory (DRAM). Video memory 1414 is a dual-ported video random access memory. One port of the video memory 1414 is coupled to the video amplifier 1416. The video amplifier 1416 is used to drive the display 1417. Video amplifier 1416 is well known in the art and may be implemented by any suitable means. This circuitry converts pixel DATA stored in video memory 1414 to a raster signal suitable for use by display 1417. Display 1417 is a type of monitor suitable for displaying graphic images.

The computer system described above is for purposes of example only. The artificial intelligence (AI) story generation environment 100 and process 200 may be implemented in any type of computer system or programming or processing environment. It is contemplated that the artificial intelligence (AI) story generation environment 100 and process 200 might be run on a stand-alone computer system, such as the one described above. The artificial intelligence (AI) story generation environment 100 and process 200 might also be run from a server computer systems system that can be accessed by a plurality of client computer systems interconnected over an intranet network. Finally, the artificial intelligence (AI) story generation environment 100 and process 200 may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A story generation method comprising:
executing code by one or more processors to cause the computer system to perform operations comprising:
providing a story generation computer system having a user interface and an integrated chatbot;
creating a user profile including one or more user details, wherein creating the user profile includes providing user inputs directly through the user interface or via interacting with the chatbot;
assigning a reading level value to the user profile based on the received user details;
storing the user details and the default reading level value in a memory operatively coupled to the user interface;
identifying one or more story topics based on the user details and the default reading level value;
guiding and constraining one or more AI engines to transform the user profile, reading level, and story topics into a story, wherein uiding and constraining one or more AI engines to transform the user profile, reading level, and story topics comprises:
identifying user details to be used in the story including at least one character and one or more incidents or interests from the user profile to personalize the story;
generating the story based on the identified details and the default reading level value of the user; and
converging the reading level value of the story with the user's default reading level value using an iterative reading level value adjustment process in order to adapt with the complexity level of the story.

2. The method of claim 1 wherein identifying the story topic further comprises referring to one or more educational standards including Common Core State Standards (CCSS), NGSS (Next Generation Science Standards) and AP.

3. The method of claim 1 wherein identifying the story topic for story generation further comprises:
receiving one or more educational topics from one or more curriculums relevant to the user profile, wherein relevancy of the educational topics is based on age or level of education of the user;
comparing the received educational topics to the user profile and recent interactions of the user with the chatbot, wherein user profile includes one or more user interests, hobbies, and incidents; and
extracting one or more educational topics matching the user profile.

4. The method of claim 3 wherein identifying the story topic for story generation from the user profile further includes a selection algorithm to prioritize one or more interests and one or more incidents extracted from the recent chat interaction of the user with the chatbot over the interests and incidents pre-stored in the user profile for increased relevance.

5. The method of claim 1 further comprising:
generating multiple choice questions (MCQs) based on the generated story for accessing the understanding level of the user, wherein the reading level value of the user is updated based on the response of the user to the MCQs.

6. The method of claim 1 wherein the AI engines used for generating a personalized story includes prompt engineering and prompt chaining techniques.

7. The method of claim 1 wherein assigning the reading level value to the user profile comprises evaluating reading ability of the user using one or more reading level assessment tools.

8. The method of claim 1 further comprises a trained Large Language Model (LLM) including ChatGPT, wherein the LLM is trained to perform within a set of guidelines to generate a factually right and interesting story.

9. A story generation system comprising:
a user interface including a chatbot integrated to allow communication between a user and the story generation system;
a memory operatively coupled to the user interface configured to store one or more user details and a default reading level value;
one or more processors; and
a memory, coupled to the one or more processors, to cause a computer system to perform operations comprising:
providing a story generation computer system having a user interface and an integrated chatbot;
creating a user profile including one or more user details, wherein creating the user profile includes providing user inputs directly through the user interface or via interacting with the chatbot;
assigning a reading level value to the user profile based on the received user details;
storing the user details and the default reading level value in a memory operatively coupled to the user interface;
identifying one or more story topics based on the user details and the default reading level value;
guiding and constraining one or more AI engines to transform the user profile, reading level, and story topics into a story, wherein uiding and constraining one or more AI engines to transform the user profile, reading level, and story topics comprises:
identifying user details to be used in the story including at least one character and one or more incidents or interests from the user profile to personalize the story;
generating the story based on the identified details and the default reading level value of the user; and
converging the reading level value of the story with the user's default reading level value using an iterative reading level value adjustment process in order to adapt with the complexity level of the story.

10. The system of claim 9 wherein the reading level value adjustment module is configured to divide a broad range of reading level values into distinct reading level buckets and comparing the default reading level value to reading level buckets thereby adjusting the complexity of the generated story according to the relevancy of the user reading level value to corresponding reading level bucket.

11. The system of claim 9 wherein the story generator is further configured to generate personalized stories with different levels of complexities including low, medium and high reading level values to maintain with user's reading capabilities.

12. The method of claim 9 wherein the story topic identifier is further configured to rank the identified story topics based on relevance of the topics to the user profile and user interests and incidents identified from latest chatbot interactions, wherein the story topic matching with recently added user details, incidents and interests are ranked higher compared to unmatched topics.

13. The system of claim 9 wherein the chatbot further comprises:
natural language processing capabilities to engage the user in conversation and thereby collecting relevant user details for personalized story generation.

14. The system of claim 9 further comprises:
a MCQ generator to generate multiple-choice questions (MCQs) based on the generated story for assessing reading capabilities of the user, wherein the reading level value of the user is updated based on the response of the user to the MCQs.

15. The system of claim 14 wherein the MCQ generator is further configured to dynamically adjust the difficulty level of the generated MCQs based on user's performance history in order to provide an adaptive assessment experience to the user.

16. The system of claim 9 wherein an output displayed to the user on the user interface comprises:
a personalized story greater than 350 words; and
a set of multiple-choice questions (MCQs) related to the story generated.

17. The system of claim 9 further comprises:
a Large Language Model (LLM) trained to perform within a set of guidelines to generate a factually right and interesting story.

18. The system of claim 17 wherein the LLM is configured to generate a personalized story using prompt engineering and prompt chaining techniques.

19. The system of claim 17 wherein the LLM includes ChatGPT.

20. The system of claim 9 wherein the one or more educational standards include Common Core State Standards (CCSS), NGSS (Next Generation Science Standards) and AP.
